(19) United States
(12) Patent Application Publication
(10) Pub. No.: US 2023/0366272 A1
(43) Pub. Date: Nov. 16, 2023

(54) FABRICATING DRILL BITS

(71) Applicant: Saudi Arabian Oil Company, Dhahran (SA)

(72) Inventors: Guodong Zhan, Dhahran (SA); Jianhui Xu, Dhahran (SA); Timothy E. Moellendick, Dhahran (SA)

(21) Appl. No.: 17/740,741

(22) Filed: May 10, 2022

(51) Int. Cl. E21B 10/567; B22F 7/06; B33Y 80/00

(52) U.S. Cl. CPC E21B 10/567; B22F 7/062; B33Y 80/00; B22F 10/14

(57) ABSTRACT

A method of fabricating a drill bit is described. The method includes forming a mold with interior surfaces defining a mold cavity within the mold, the mold cavity having a shape corresponding to a shape of a body of the drill bit; forming catalyst-free synthesized polycrystalline diamond compact (PDC) cutting elements using an ultra-high pressure and temperature process; determining positions of the catalyst-free synthesized PDC cutting elements within the mold cavity; placing the catalyst-free synthesized PDC cutting elements at the determined positions within the mold cavity; filling the mold cavity with matrix materials of the body of the drill bit; and bonding the catalyst-free synthesized PDC cutting elements with the matrix materials of the body to form an impregnated drill bit.

### TECHNICAL FIELD

The present disclosure generally relates to fabricating drilling tools for drilling into subterranean formations, more particularly to a method of fabricating drill bits with imbedded catalyst-free synthesized polycrystalline diamond compact (PDC) cutting elements.

### BACKGROUND

Designed for hard, abrasive formations, conventional diamond drill bits use application-specific materials to withstand rigorous drilling conditions. They are capable of drilling out float equipment and are effective for drilling ultra-hard formations.

For increased durability and rate of penetration (ROP), conventional drill bits include grit hot pressured inserts, PDC cutters with catalyst, thermally stable polycrystalline diamonds, and diamond-impregnated matrix materials.

### SUMMARY

This specification describes a method for fabricating drill bits that include catalyst-free synthesized PDC cutting elements. The fabrication method includes a mold with a determined positioning for imbedding the catalyst-free synthesized PDC cutting elements into drill bits. This approach allows design of drill bits with blade profiles of varying diamond size and density. The methods described in this specification include a bonding procedure to attach catalyst-free synthesized PDC cutting elements to the materials forming the body of the drill bit. The drill bits with catalyst-free synthesized PDC cutting elements can be used to improve drilling efficiency in oil and gas wellbore formations.

A mold formed from a metal block has an interior surface that defines a mold cavity. The mold cavity has a shape corresponding to a shape of a body of the drill bit to be fabricated. In a separate step, catalyst-free synthesized PDC cutting elements are fabricated using ultra-high pressure and high temperature (UHPHT) processes (e.g., UHPHT processes such as those disclosed in U.S. Patent Publication No. US20210370396). In some implementations, the catalyst-free synthesized PDC cutting elements are also substrate-free. The catalyst-free synthesized PDC cutting elements are placed within the mold cavity at determined positions and matrix materials of the body are poured into the mold cavity. The matrix materials include diamond particles, tungsten carbide particles, or ceramic-metal composite, or their combinations. A metal infiltrant powder or chunks are placed on the top of all these. A bonding process (e.g., sintering) is initiated by applying a temperature between 850 and 1150 degrees Celsius (° C.) to the mold to allow the infiltrant to infiltrate into the whole mold.

The bonding treatment initiates a flow of metal infiltrant between the matrix materials of the body and the catalyst-free synthesized PDC cutting elements as a result of the applied temperature. The infiltrant in liquid form at such temperature is to flow into the places between the particles in the matrix material due to the capillary force as well as the gravity. After the bonding treatment is terminated, the matrix materials of the body and the catalyst-free synthesized PDC cutting elements within the mold are cooled. The final bit with catalyst-free synthesized PDC cutting elements is formed and will be used as a ready drill bit for drilling subterranean formations. In such implementations, the bonding process is a hot infiltration process. In some other implementations, the bonding process is a combination of additive manufacturing and sintering processes.

The ability of the catalyst-free synthesized PDC cutting elements to survive the infiltration process at high temperatures (e.g., between 850 and 1150° C.) due to the absence of metallic catalyst (e.g., cobalt binder), allows them to be imbedded into the drill bit and treated at high temperature. Such PDC cutting elements without catalyst can survive up to 1400° C. without thermal degradation during either infiltration process or sintering process. The drill bit exhibits thermal stability and improved properties that can survive in a harsh drilling environment without costly bit tripping.

The described approach enables the production of drill bits with flexible, application-specific blade designs that can provide faster drilling over longer time intervals in hard and abrasive formations, improved tool performance, and reductions in the number of bits necessary in operation and in the cost per drilling foot. The integration of the catalyst-free synthesized PDC cutters enable “One-Run-To-Total-Depth” drilling approach where one drill bit is used for the entire drilling operation without the need to replace the drill bit midway during the drilling process.

In some aspects, a method of fabricating a drill bit includes: forming a mold with interior surfaces defining a mold cavity within the mold, the mold cavity having a shape corresponding to a shape of a body of the drill bit; forming catalyst-free synthesized polycrystalline diamond compact (PDC) cutting elements using an ultra-high pressure and temperature process; determining positions of the catalyst-free synthesized PDC cutting elements within the mold cavity; placing the catalyst-free synthesized PDC cutting elements at the determined positions within the mold cavity; filling the mold cavity with matrix materials of the body of the drill bit; and bonding the catalyst-free synthesized PDC cutting elements with the matrix materials of the body to form an impregnated drill bit.

Embodiments of the method for fabricating a drill bit can include one or more of the following features.

In some embodiments, the method includes filling the mold cavity with particles of hard-phase material and metallic binders. In some cases, the method includes infiltrating the particles of hard-phase material, the metallic binders, and the catalyst-free synthesized PDC cutting elements at a temperature between 850 and 1150° C. In some cases, the method includes spraying the particles of hard-phase material onto the catalyst-free synthesized PDC cutting elements using an additive manufacturing process. In some cases, the method includes injecting an ink after spraying the particles of hard-phase material onto the catalyst-free synthesized PDC cutting elements using the additive manufacturing process. In some cases, the method includes the additive manufacturing process is a binder jetting process. In some cases, the method includes curing the injected ink onto the catalyst-free synthesized PDC cutting elements using an ultraviolet (UV) light. In some cases, the method includes forming a green part that includes the catalyst-free synthesized PDC cutting elements and the matrix materials of the body. In some cases, the method includes sintering the green part at a temperature between 850 and 1150° C. to form the impregnated drill bit. In some cases, the method includes forming a covalent bond between the catalyst-free PDC cutting elements and the matrix materials of the body using a copper-based alloy binder.

In some embodiments, the method includes placing substrate-free and catalyst-free synthesized PDC cutting elements at the determined positions within the mold cavity.

In some aspects, a drill bit includes: a body with matrix materials and having a lower end for engaging a rock formation; and a plurality of imbedded polycrystalline diamond compact (PDC) cutting elements extending from a face of the body to an outer surface of the body and separated by a plurality of passageways formed within the face of the body. Each of the plurality of the imbedded PDC cutting elements is a catalyst-free synthesized PDC cutting element and imbedded into a determined position of the face of the body using an ultra-high pressure and temperature bonding process.

Embodiments of the drill bit can include one or more of the following features.

In some embodiments, the matrix materials of the body includes particles of hard-phase material and metallic binders.

In some embodiments, the drill bit is a green part that includes the plurality of imbedded catalyst-free synthesized PDC cutting elements and the matrix materials of the body.

In some embodiments, the drill bit includes a plurality of imbedded substrate-free and catalyst-free synthesized PDC cutting elements. In some cases, the drill bit is a green part that includes the plurality of imbedded substrate-free and catalyst-free synthesized PDC cutting elements and the matrix materials of the body. In some cases, the drill bit includes the plurality of the imbedded catalyst-free synthesized PDC cutting elements, the matrix materials of the body, and a copper-based alloy binder.

Drill bits including the catalyst-free synthesized PDC cutting elements can be used with high-speed hydraulic motors and turbines when drilling formations. The high rotational speed and increased thermal stability allow for large rock destruction. The integration of diamond elements in the blade profile of the bit increases durability of the gauge and the front parts of the bit in abrasive formations. Imbedding the catalyst-free synthesized PDC cutting elements into the drill bit can close structure performance gaps and overcome the current drilling challenges. The catalyst-free synthesized PDC cutting elements provide improved mechanical and thermal properties (e.g., improved wear and impact resistance) that enables the drill bits to improve drilling efficiency in extremely hard and abrasive formations. The drilling can be completed at a reduced time and with an improved rate of penetration (ROP) over current drill bits.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of drilling into a subsurface reservoir using a drilling assembly.

FIG. 2 is a perspective view of an example drill bit with PDC cutting elements.

FIG. 3 is a perspective view of a damaged drill bit.

FIG. 4 is a flowchart of a method for fabricating a drill bit with catalyst-free synthesized PDC cutting elements.

FIG. 5 is a schematic view of a mold used for fabricating the drill bit with catalyst-free synthesized PDC cutting elements.

FIG. 6 is a schematic view of a direct ink printing equipment used for fabricating the drill bit with catalyst-free synthesized PDC cutting elements.

FIGS. 7A-7B show examples of drill bits produced with the described method.

### DETAILED DESCRIPTION

This specification describes a method for fabricating drill bits that include catalyst-free synthesized PDC cutting elements. The fabrication method includes a mold with a determined positioning for imbedding the catalyst-free synthesized PDC cutting elements. This approach allows a design of drill bits with blade profiles of varying diamond size and density. The methods described in this specification include a bonding procedure to fabricate the drill bit with catalyst-free synthesized PDC cutting elements. The drill bits with catalyst-free synthesized PDC cutting elements can be used to improve drilling efficiency in oil and gas wellbore formations.

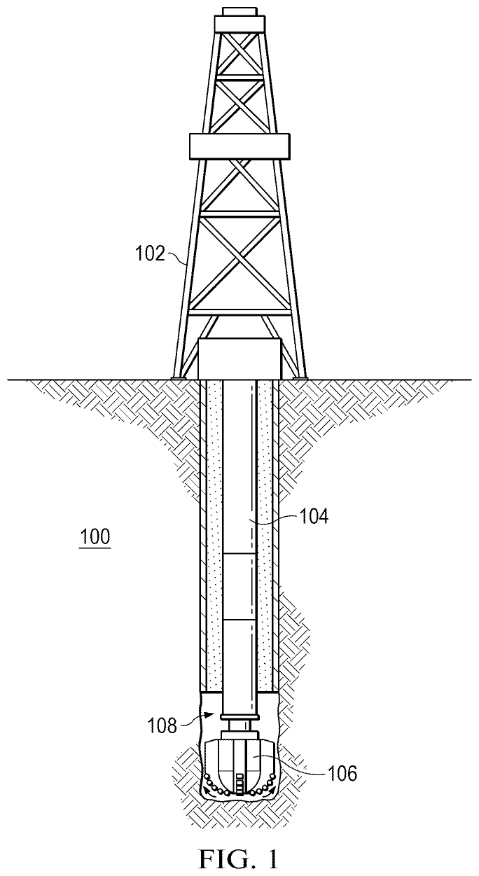

FIG. 1 is a schematic view of drilling into a subsurface reservoir 100 using a drilling assembly 104. The wellsite includes a derrick 102 that supports the drilling assembly 104 with the drill bit 106 for forming a wellbore 108.

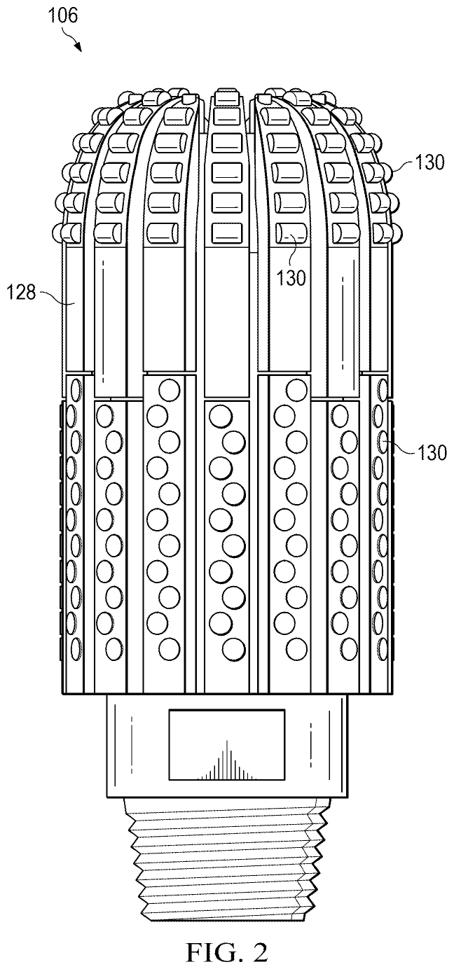

FIG. 2 is a perspective view of a drill bit 106 with PDC cutting elements 130. The drill bit 106 is impregnated drill bit. The impregnated drill bits are bits in which diamond cutting elements 130 are completely imbedded within a bit body matrix 128. The body 128 of the impregnated bit includes PDC matrix materials that are similar to those used in the PDC cutting elements 130. As illustrated, the impregnated drill bit 106 includes a plurality of PDC cutting elements 130 imbedded within a bit body matrix 128. The plurality of PDC cutting elements 130 form a blade profile that provides a complete diamond coverage of the well bottom with only diamonds touching the subterranean formation. The plurality of PDC cutting elements 130 can include variable diamond sizes and ratios of diamond content to body matrix volumes that can affect the performance of the drill bit in terms of aggressiveness and durability. For example, typical diamond concentration is between 12 and 38 volume percent (%) and size is between 0.3 and 1 mm. The PDC cutting elements 130 operate to cut into the rock to form wellbores. Drilling highly abrasive formations poses a challenge for impregnated drill bits resulting in extremely low ROP and short bit life. For example, a high RPM from high-speed motor or turbine used with impregnated drill bits can cause increase in heat in the cutting elements. The described drill bits can provide sufficient wear or impact resistance, and adequate thermal stability to survive harsh drilling environment without failure.

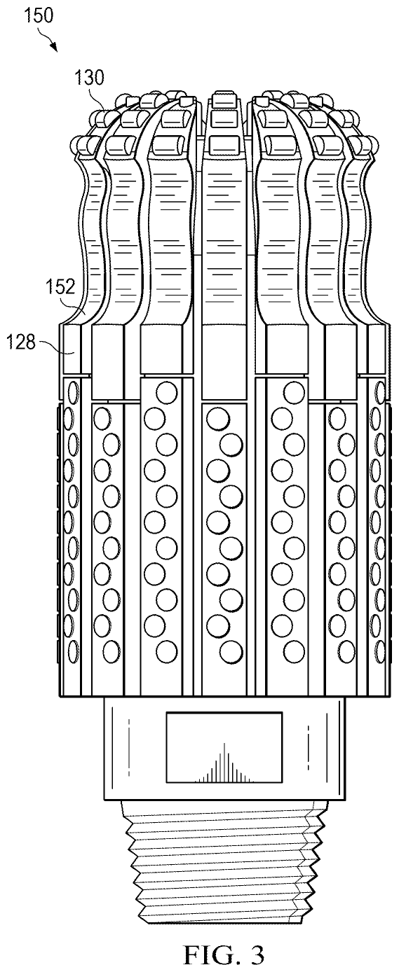

FIG. 3 is a perspective view of a damaged drill bit 150. As illustrated, most of the cutting elements 130 are damaged with dull, ruined regions 152 left on the drill bit 150 such that the drill bit is unable to continue the drilling operation. Drill bits including imbedded cutting elements with improved mechanical and thermal properties can overcome the challenges of the current impregnated drill bits. Drill bits with catalyst-free synthesized PDC cutting elements can enable drilling operations in highly abrasive formations to be carried out to completion with less trips and reduced operation time.

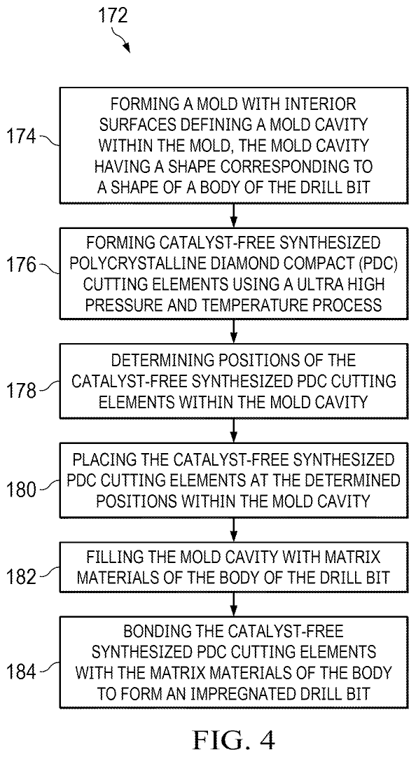

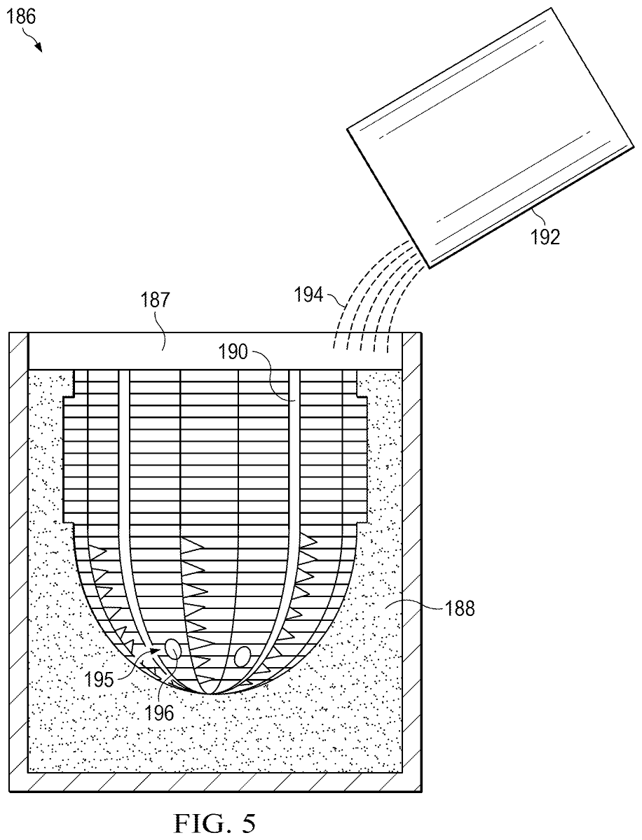

FIG. 4 is a flowchart of a method 172 for fabricating a drill bit with catalyst-free synthesized PDC cutting elements. The method 172 begins by forming a mold, step 174 (details of a mold are described with reference to FIG. 5). The mold can be formed by milling a block of material (e.g., graphite) to form at least one interior surface defining a mold cavity. The interior surface of the mold cavity provides a shape corresponding to features and shapes of an exterior surface of the desired body of the drill bit to be fabricated. The interior surface of the mold cavity can include recesses at determined locations shaped to define profiles for plurality of blades with catalyst-free synthesized PDC cutting elements for fabrication of the drill bit. Other various features of the desired bit body, such as additional cutting elements positions and/or internal fluid passageways, can also be formed. Additional features can be formed within the mold by shaping the interior surface of the mold cavity and/or by positioning various temporary displacement materials within interior portions of the mold cavity.

The catalyst-free synthesized PDC cutting elements are formed using UHPHT process (step 176). For example, the UHPHT process includes forming catalyst-free synthesized PDC cutting elements using compressive pressure between 14 GPa and 36 GPa, and temperature between 1300 Kelvins (K) and 2600 K. Further details of a UHPHT process are described in U.S. patent application Ser. No. 16/524,935 filed on Jul. 29, 2019, U.S. Patent Application No. 63/031,077 filed on May 28, 2020, and U.S. Patent Application No. 63/033,669 filed on Jun. 2, 2020, the entire contents of which are incorporated here by reference. In some implementations, the catalyst-free synthesized PDC cutting elements are also substrate-free (e.g., a PDC cutting element is formed without a tungsten carbide substrate using the UHPHT process).

UHPHT cutting elements production methods may take from eight hours to twelve hours to complete. The UHPHT methods use pressures (e.g., 14 GPa to 36 GPa) greater than pressures used in current HPHT methods which use pressures within a range of 5.5 GPa and 7 GPa. In some implementations, UHPHT methods use pressures that exceed 36 GPa. Additional processes can be used to achieve a desired shape of the catalyst-free synthesized PDC cutting elements once the cutting elements are formed using UHPHT process. For example, processes such as laser cutting or mechanical grinding of the cylinder-shaped cutters can be used to achieve the desired final shape of the catalyst-free synthesized PDC cutting elements.

The position for each catalyst-free synthesized PDC cutting element is determined within the mold cavity (step 178). A number of elements, sizes, shapes, and spacing of the catalyst-free synthesized PDC cutting elements are determined for each drill bill design. In some implementations, the catalyst-free synthesized PDC cutting elements are formed with surfaces defining holes, cutouts or other shapes that correspond with desired exterior features of the resulting drill bit.

In some implementations, the interior surface of the mold cavity has determined positions for multiple catalyst-free synthesized PDC cutting elements. In some implementations, the catalyst-free synthesized PDC cutting elements are positioned at an equal distance apart and across from one another. In some implementations, the catalyst-free synthesized PDC cutting elements are positioned at a varying distances apart and parallel from one another within the mold cavity. In some implementations, the catalyst-free synthesized PDC cutting elements are positioned circumferentially around the perimeter of the mold cavity.

The positioning of the catalyst-free synthesized PDC cutting elements within the mold cavity can be strategically determined to achieve mechanical retention within the drill bit. In some implementations, determining the position of the catalyst-free synthesized PDC cutting elements is focused on application-specific designs with predetermined diamond size and density. This strategic approach can enable improved central fluid flow distribution for efficient cooling and cleaning, and greater gauge protection within the drill bit. For example, the hydraulic channel can be processed in a way that these PDC cutting elements can be cooled in a direct injection of the mold. In some implementations, determining the position of the catalyst-free PDC cutting elements is focused on forming impregnated drill bits for drilling softer formations. In some implementations, determining the position of the catalyst-free synthesized PDC cutting elements is focused on forming drill bits for drilling mixed (e.g., soft and hard) formations.

The catalyst-free synthesized PDC cutting elements are placed at the determined positions within the mold cavity (step 180).

The mold cavity is filled with the other hard materials of the body of the desired drill bit to be fabricated (step 182). The bulk of the hard materials of the drill bit body is poured into the mold cavity. In some implementations, the matrix materials include diamond particles, tungsten carbide particles or a ceramic-metal composite material, or any of their combinations. For example, hard ceramic particles such as tungsten carbide particles can be cemented together with a metal matrix material to form a continuous metal matrix within the bit body in which the hard particles are embedded. In some implementations, the bit body includes a copper-based alloy binder that provides a good bonding (e.g., covalent bond) between the bit body and the catalyst-free synthesized PDC cutting elements. This also creates the feasibility of direct placement of the catalyst-free synthesized PDC cutting elements during manufacturing of the drill bit.

Once all elements are placed into the interior surface of the mold cavity, a bonding process between the catalyst-free synthesized PDC cutting elements and the matrix materials of the body begins to form the impregnated drill bit (step 184). In some implementations, the bonding process includes infiltrating the catalyst-free synthesized PDC cutting elements with the matrix materials of the body (e.g., the diamond particles, tungsten carbide particles or ceramic-metal composite particles) at a temperature between 850 and 1150° C. In operation, the infiltrant is placed on top of hard powders after poured in the mold. Gradual increase in temperature melts the infiltrant. The infiltrant transitions to a liquid phase and enters, upon capillary force, into gaps formed among the hard particles. In time a cooling phase begins and the hard particles are bonded to each other and to the PDC cutting elements when the infiltrant solidifies. During the infiltration process, a metallurgical bond between the catalyst-free synthesized PDC cutting elements and the bit body is achieved. The absence of the catalyst in the synthesized PDC cutting elements allows the cutting elements to resist a high temperature (e.g., up to 1400° C.) and to survive the infiltration process. The mold cavity is heated at a rate between 1 and 20° C. per minute until a temperature of approximately 850-1150° C. is reached. After the infiltration process is complete the matrix materials of the body including the catalyst-free synthesized PDC cutting elements are cooled, solidified, and shaped into the final form of the impregnated drill bit.

In some implementations, the bonding process is an additive manufacturing process (e.g., a 3D printing or a binder jetting process). In this approach, the catalyst-free synthesized PDC cutting elements are placed into the determined position of the mold cavity. The hard particles of the matrix material of the bit body can then be sprayed on and around the catalyst-free synthesized PDC cutting elements inside the mold cavity. The process can be done in a layer-by-layer application and after each layer of hard particles is sprayed on, an ink can be injected to connect all elements inside the mold cavity. A curing process (e.g., ultraviolet light (UV)) is applied to dry the ink. After each layering cycle, a green part is formed encapsulating the catalyst-free synthesized PDC cutting elements. The processing cycle is repeated until the impregnated bit body is formed. The completed impregnated drill bit is placed into an environmental chamber and a sintering process, at a temperature between 850 and 1150° C., begins. The sintering process helps to eliminate moisture from the organic or aqueous ink and to solidify the impregnated drill bit. Similar to the infiltration process, the catalyst-free synthesized PDC cutting elements have a strong bond with the matrix materials of the body and form the final impregnated bit body.

FIG. 5 is a schematic view of a mold 186 used for fabricating the drill bit 187 with the catalyst-free synthesized PDC cutting elements 195. The mold 186 includes an interior surface 188 defining a mold cavity 190. The mold cavity 190 includes determined locations 196 sized to receive catalyst-free synthesized PDC cutting elements 195. In some implementations, the interior surface 188 of the mold cavity 186 and/or the outer surface of the catalyst-free synthesized PDC cutting elements 195 are formed to have ridges, ribs, waveforms, bubbles, honeycombs, lattices, or other textures on all the surfaces or on a portion of the surfaces. Such features on the surfaces can aid in better alignment of the catalyst-free synthesized PDC cutting elements 195 with the interior surface 188 of the mold cavity 190 or to provide consistent repeatable alignment with tolerances from about 0.1 millimeters (mm) to about 5 mm. In some implementations, the features or textures on the surfaces of the catalyst-free synthesized PDC cutting elements 195 or the internal surface 188 of the mold cavity 190 are used to improve adhesion. For example, to improve adhesion and mechanical locking during placement of the catalyst-free synthesized PDC cutting elements 195 into the mold cavity 190. As illustrated, the process of forming the drill bit 187, using the mold 186, includes a container 192 carrying mixture of the matrix materials 194 to be poured into the mold cavity 190.

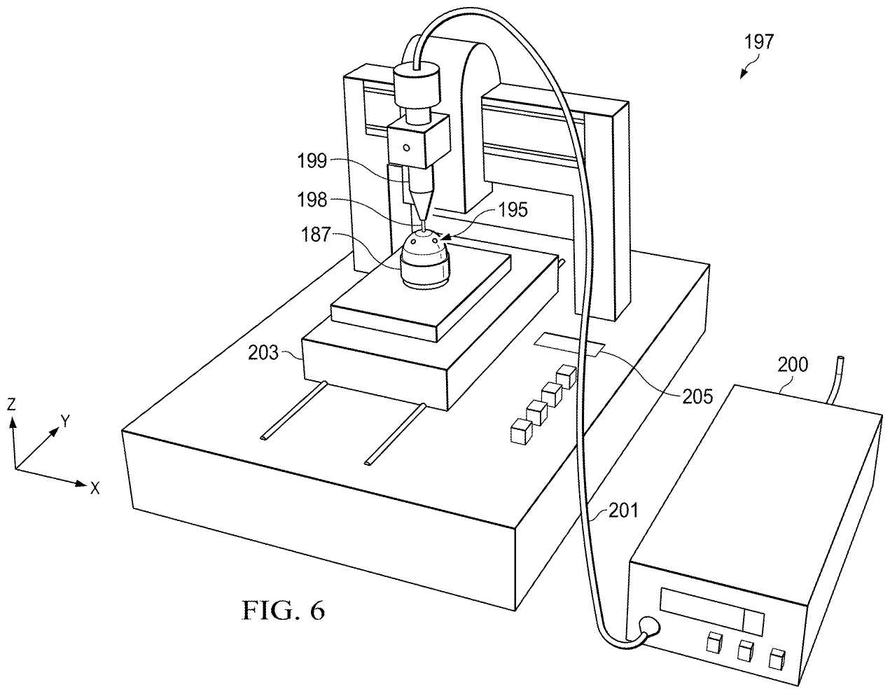

FIG. 6 is a schematic view of a direct ink printing equipment 197 used for fabricating the drill bit 187 with catalyst-free synthesized PDC cutting elements 195. The direct ink printing method is an extrusion-based process that offers rapid fabrication of 3D complex structures by deposition of colloidal inks in a layer-by-layer approach. The layer-by-layer approach allows the printing of 3D structures with improved properties and functionality. The direct ink printing method can be compatible with a wide range of materials such as polymers, ceramics, metals, composites, and combinations thereof. The direct ink printing method uses 3D printer 197 (e.g., Hyrel3D 30M system), at room temperature, to spray the hard particles of the matrix material of the bit body on and around the catalyst-free synthesized PDC cutting elements 195. After each layer of hard particles is sprayed on, an ink 198 can be injected to connect the catalyst-free synthesized PDC cutting elements 195 with the body of the drill bit 187. The 3D printer 100 includes a cold flow syringe head 199 (e.g., SDS-30 Extruder) to extrude the ink 198 layer-by-layer and connect the catalyst-free synthesized PDC cutting elements 195 with the body of the drill bit 187 at ambient conditions. The 3D printer 197 is attached to a pressure controller 200 via an air pressure pipe 201 that pressurizes the syringe head 199 to deposit the ink 198. The ink 198 is deposited on the body of the drill bit 187 that facilitates ease of post structure removal from the print bed. The body of the drill bit 187 is placed on a moving stage 203 that can move in x, y, and z-directions. Prior to printing, the user uses software (e.g., Slic3r based on a G-code script) to generate a specific printing job. The printing job can include a print pattern and geometry, layer height, extrusion width, printing speed, and printing orientation. The display screen 205 shows the printing job in progress.

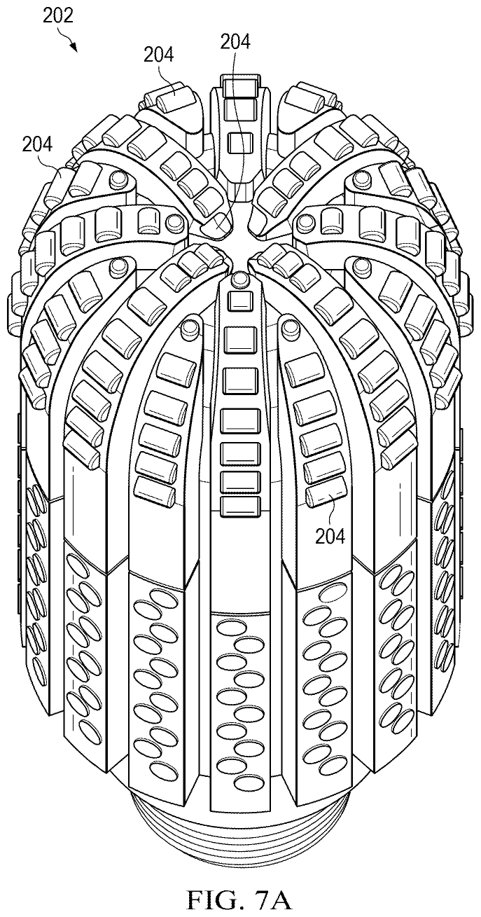

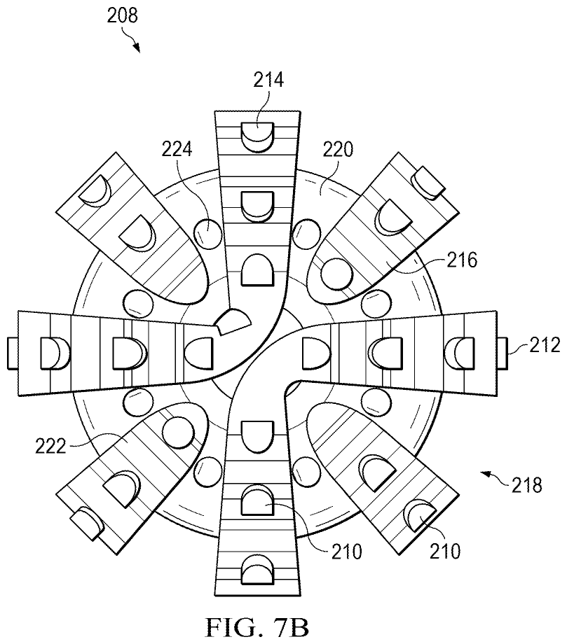

FIGS. 7A-7B show examples of drill bits 202, 208 produced with the described method 172. Based on the type of formation where drilling will be performed, the drill bits 202, 208 are formed with catalyst-free synthesized PDC cutting elements in different configurations. For example, the drill bit 202 has a configuration where all catalyst-free synthesized PDC cutting elements 204 are equal in size, shape, and material density and form the same distribution pattern around the flow passageways 206 (as shown in FIG. 7A). In drill bit 208, only some of the PDC cutting elements are catalyst-free synthesized PDC cutting elements 210 formed using the described method 172. Other PDC cutting elements 212, 214 can be formed with a catalyst and can be integrated into the bit body 216 using brazing or/and casting process. The most wear resistant cutting elements (such as catalyst-free synthesized PDC cutting elements 204, 210) can be placed on the outer surfaces of the body 216 with increased diamond density. The complex drill bit structure can have a varying ductility and design. In this example, the drill bit 208 includes a body 216 having a lower end 218 for engaging a rock formation. Imbedded PDC cutting elements 210, 212, 214 extend from a face 220 of the body 216 to an outer surface 222 of the body 216 and the cutting elements are separated by passageways 224 formed within the face 220 of the body 216.

In some implementations, the catalyst-free synthesized PDC cutting elements are positioned adjacent to and around nozzle inserts, gage wear plugs, wear knots, dedicated fluid ports, or regions for optimal clearing. In some implementations, the catalyst-free synthesized PDC cutting elements have a circular transverse cross-sectional shape. In some implementations, a diameter D of the catalyst-free synthesized PDC cutting elements can vary according to the desired size of the drill bit. For example, the catalyst-free synthesized PDC cutting elements have a diameter D within a range of 8 mm to 48 mm. However, in other examples, the diameter D of the catalyst-free synthesized PDC cutting elements is greater than or less than the indicated range. In some implementations, the catalyst-free synthesized PDC cutting elements have a cylindrical shape. In other implementations, the catalyst-free synthesized PDC cutting elements have a tapered shape. In other implementations, the transverse cross-sectional shape of the catalyst-free synthesized PDC cutting elements is not circular. For example, the catalyst-free synthesized PDC cutting elements can be oval, square, rectangular, or have an irregular shape.

Varying design configurations of the described drill bits are beneficial for cutting and gauge protection purposes. Varying diamond distribution also affects the ratio of the diamond to matrix content with similar effects on aggressiveness and durability. During drilling, individual diamonds in a bit are exposed at different rates. Sharp, fresh diamonds are often exposed first and placed into service. Historically, PDC cutters, fully imbedded within a PDC drill bit body matrix, dull due to abrasive wear, impact damage, and thermal fatigue. Hardness, fracture toughness, thermal stability, and varying distribution and positioning of the catalyst-free synthesized PDC cutting elements within the matrix volumes allow increased performance of the drill bits in terms of aggressiveness and durability in harsh drilling environments. Different designs can also improve hydraulics of the drill bits that enables improved drilling of the formations with high ROPs and reduced need to trip to change bit type.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Accordingly, the previously described example implementations do not define or constrain the present disclosure. Other changes, substitutions, and alterations are also possible without departing from the spirit and scope of the present disclosure.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method of fabricating a drill bit, the method comprising:
forming a mold with interior surfaces defining a mold cavity within the mold, the mold cavity having a shape corresponding to a shape of a body of the drill bit;
forming catalyst-free synthesized polycrystalline diamond compact (PDC) cutting elements using an ultra-high pressure and temperature process;
determining positions of the catalyst-free synthesized PDC cutting elements within the mold cavity;
placing the catalyst-free synthesized PDC cutting elements at the determined positions within the mold cavity;
filling the mold cavity with matrix materials of the body of the drill bit; and
bonding the catalyst-free synthesized PDC cutting elements with the matrix materials of the body to form an impregnated drill bit.

2. The method of claim 1, wherein filling the mold cavity with matrix materials of the body comprises filling the mold cavity with particles of hard-phase material and metallic binders.

3. The method of claim 2, wherein bonding the catalyst-free synthesized PDC cutting elements with the matrix materials of the body comprises infiltrating the particles of hard-phase material, the metallic binders, and the catalyst-free synthesized PDC cutting elements at a temperature between 850 and 1150° C.

4. The method of claim 2, wherein filling the mold cavity with matrix materials of the body comprises spraying the particles of hard-phase material onto the catalyst-free synthesized PDC cutting elements using an additive manufacturing process.

5. The method of claim 4, wherein filling the mold cavity with matrix materials of the body comprises injecting an ink after spraying the particles of hard-phase material onto the catalyst-free synthesized PDC cutting elements using the additive manufacturing process.

6. The method of claim 5, wherein the additive manufacturing process is a binder jetting process.

7. The method of claim 5, further comprising curing the injected ink onto the catalyst-free synthesized PDC cutting elements using an ultraviolet (UV) light.

8. The method of claim 7, further comprising forming a green part that includes the catalyst-free synthesized PDC cutting elements and the matrix materials of the body.

9. The method of claim 8, further comprising sintering the green part at a temperature between 850 and 1150° C. to form the impregnated drill bit.

10. The method of claim 1, further comprising placing substrate-free and catalyst-free synthesized PDC cutting elements at the determined positions within the mold cavity.

11. The method of claim 2, wherein bonding comprises forming a covalent bond between the catalyst-free PDC cutting elements and the matrix materials of the body using a copper-based alloy binder.

12. A drill bit comprising:
a body comprising matrix materials and having a lower end for engaging a rock formation; and
a plurality of imbedded polycrystalline diamond compact (PDC) cutting elements extending from a face of the body to an outer surface of the body and separated by a plurality of passageways formed within the face of the body;
wherein each of the plurality of the imbedded PDC cutting elements is a catalyst-free synthesized PDC cutting element and imbedded into a determined position of the face of the body using a ultra-high pressure and temperature bonding process.

13. The drill bit of claim 12, wherein the matrix materials of the body comprise particles of hard-phase material, and metallic binders.

14. The drill bit of claim 12, wherein the drill bit is a green part that includes the plurality of imbedded catalyst-free synthesized PDC cutting elements and the matrix materials of the body.

15. The drill bit of claim 12, wherein the drill bit comprises a plurality of imbedded substrate-free and catalyst-free synthesized PDC cutting elements.

16. The drill bit of claim 15, wherein the drill bit is a green part that includes the plurality of imbedded substrate-free and catalyst-free synthesized PDC cutting elements and the matrix materials of the body.

17. The drill bit of claim 12, wherein the drill bit comprises the plurality of the imbedded catalyst-free synthesized PDC cutting elements and the matrix materials of the body joined by a covalent bond.

18. The drill bit of claim 17, wherein the drill bit comprises the plurality of the imbedded catalyst-free synthesized PDC cutting elements, the matrix materials of the body, and a copper-based alloy binder.

19. The drill bit of claim 18, wherein the drill bit comprises a plurality of the imbedded substrate-free and catalyst-free synthesized PDC cutting elements, the matrix materials of the body, and the copper-based alloy binder.
